(19) United States
(12) Patent Application Publication
(10) Pub. No.: US 2010/0077659 A1
(43) Pub. Date: Apr. 1, 2010

(54) Method of Applying Particulate Groundcover Around Plants

(76) Inventor: Sandra Shove, Racine, WI (US)

Correspondence Address: JANSSON SHUPE & MUNGER LTD., 245 MAIN STREET, RACINE, WI, 53403, US

(21) Appl. No.: 12/241,179

(22) Filed: Sep. 30, 2008

(51) Int. Cl. A01G 7/00

(52) U.S. Cl. 47/9

(57) ABSTRACT

The present method is an improved method of applying particulate groundcover around plants. This method involves the steps of providing a plurality of substantially planar flexible sheet-members each including an outer surface and an opposite inner surface and first and second opposed edges, die inner surface having a first-edge-adjacent portion with a first surface-fastener patch thereon, the outer surface having a second surface-fastener patch thereon extending from near the second edge toward the first edge; wrapping each sheet-member about the leafy portion of a plant into a substantially cylindrical shape and temporarily securing together the first and second patches thereof to expose the base of the plant stem and surrounding ground; applying groundcover around and between the plants including to the bases of the stems thereof; and decoupling the first and second patches of each sheet-member and removing the sheet-members to allow the leafy portions of the plant to spread over the groundcover.

### FIELD OF THE INVENTION

This invention relates to a method of applying particulate groundcover and more particularly to a method of applying particulate groundcover around the base portion of numerous plants which is simple and efficient.

### BACKGROUND OF THE INVENTION

Temporary, reusable landscaping devices are utilized to allow an individual to easily spread particulate groundcover such as bark, mulch or topsoil around the base of a plant or several plants. Landscaping devices in the prior art typically consist of a placing an apparatus which is anchored to the earth around a plant for the purpose of protecting the plant. Other landscaping devices in the prior art are placed around a plant to create a sheltered climate of higher temperatures and increased humidity around the plant. Still other devices in the prior art are placed around a plant as a frost protector or growth enhancer. Examples of the prior art are disclosed in the following United Slates patents: U.S. Pat. No. 6,357,172 (Risgaard, et al.), U.S. Pat. No. 6,067,747 (Reed), U.S. Pat. No. 5,347,750 (Mills'), U.S. Pat. No. 5,323,566 (Mills) and U.S. Pat. No. 2,062,410 (Garcia).

The landscaping devices of the prior art have, however, a number of problems and shortcomings. None of the landscaping devices of the prior art disclose a method for applying particulate groundcover up to and around the base of a plant which is also simple and efficient. The landscaping devices of the prior art do not disclose such a method and are instead directed towards plant protection and growth enhancement through the use of an apparatus rather than aiding an individual in distributing particulate groundcover around and between plant bases. It would be desirable to have a method which allows the user to easily apply particulate groundcover around the bases of plants.

Traditionally the method used for applying particulate groundcover, such as bark or mulch, around the base of a plant includes the individual attempting to reach (with his or her arms and hands) as far under the plant as possible to spread the groundcover. This method has shortcomings. Oftentimes the user cannot reach far enough under the plant to spread the groundcover up to and around the base of the plant resulting in uneven distribution. Typically this occurs when the plant is large in size and leafy.

It would be desirable to have a method which enables the individual to apply particulate groundcover up to and around the base of a plant which is also simple and efficient. This method could be used when applying particulate groundcover around and between a large number of plants or around a single plant. This would make applying particulate groundcover around and between plants simple and efficient, thereby saving costs by reducing the time necessary to apply groundcover.

This invention meets these needs and overcomes other problems and shortcomings in the prior art with a method that allows an individual to easily and efficiently apply particulate groundcover around the bases of plants.

### OBJECTS OF THE INVENTION

It is an object of this invention to provide a method for applying particulate groundcover around the base of a plant which is simple.

Another object is to provide a method for applying particulate groundcover around the base of a plant which is efficient.

Another object is to provide a method for applying particulate groundcover around the bases of a number of plants.

These and other objects of the invention will be apparent from the following descriptions and from the drawings.

### SUMMARY OF THE INVENTION

The present invention discloses a method of applying particulate groundcover around the base of a plant or several plants. More specifically, the present invention discloses a method of applying particulate groundcover around the base of a plant which is easy and efficient.

The term “particulate groundcover” as used herein refers to mulch, bark, topsoil, fertilizer, sawdust or any other particulate material which is traditionally spread around and between plants for landscaping purposes.

In preferred embodiments, the method of applying particulate groundcover around plants includes providing a plurality of substantially planar flexible sheet-members. Each sheet-member includes an outer surface and an opposite inner surface and first and second opposed edges. The inner surface has a first-edge-adjacent portion with a first surface-fastener patch thereon. The outer surface has a second surface-fastener patch thereon extending from near the second edge toward the first edge. Next, the method includes wrapping each sheet-member about the leafy portion of a plant and into a substantially cylindrical shape and temporarily securing together the first and second patches thereof to expose the base of the plant stem and surrounding ground. The next step of the preferred method includes applying groundcover around and between the plants including to the bases of the stems of the plants. Finally, the method preferably includes decoupling the first and second patches of each sheet-member and removing the sheet-members to allow the leafy portions of the plant to spread over the groundcover.

It is highly preferred that the outer surface of each sheet-member has only one surface-fastener patch thereon extending in an elongate manner to facilitate wrapping the sheet-member into chosen cylindrical sizes depending on the sizes of the plants. In other preferred embodiments, the outer surface of each sheet-member has a plurality of surface-fastener patches thereon spaced apart on the outer surface in a manner facilitating wrapping the sheet-member into chosen cylindrical sizes depending on the sizes of the plants.

It is also preferable that the first and second surface-fastener patches are velcro. Preferably, each sheet-member has an upper edge and a lower edge and each sheet-member has sufficient form such that the dimensions between the upper edges and lower edges remain substantially unchanged during wrapping and use.

### BRIEF DESCRIPTION OF THE DRAWINGS

The drawings illustrate a preferred embodiment including the above-noted characteristics and features of the invention. The invention will be readily understood from the descriptions and drawings. In the drawings:

FIG. 1 is a front perspective view of the sheet-member temporarily secured around a plant.

FIG. 2 is a front perspective view of the sheet-member.

FIG. 3 is a back perspective view of the sheet-member.

FIG. 4 is a front perspective view of the sheet-member with the first and second surface-fastener-patches secured.

FIG. 5 is a section of the sheet-member taken along section line 4-4 of FIG. 4.

### DETAILED DESCRIPTION OF PREFERRED EMBODIMENTS

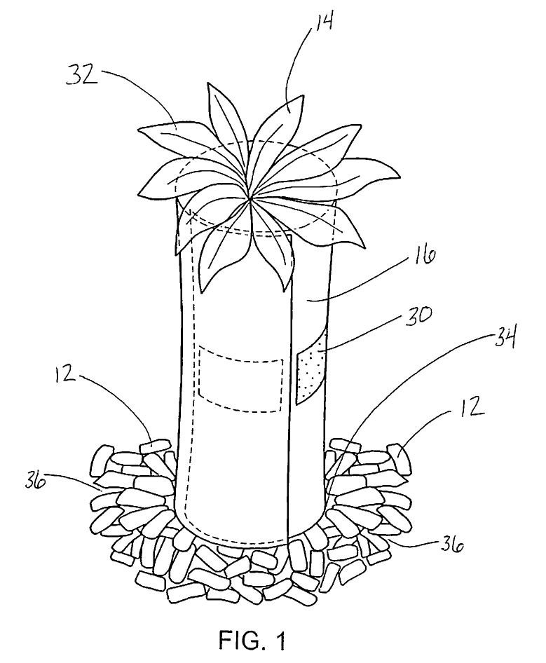

FIGS. 1-5 illustrate an improved method for applying particulate groundcover 12 to plants 14. FIGS. 1-5 illustrate a method of applying particulate groundcover 12 around one plant 14 or several plants 14. The method will be described below in detail.

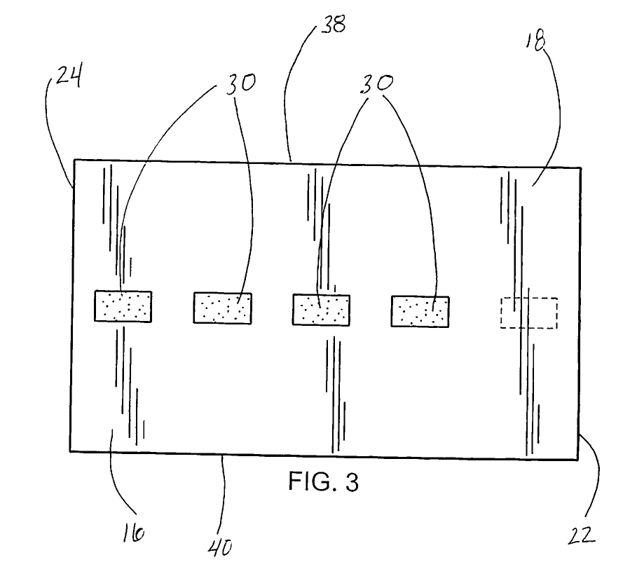

FIGS. 1-5 illustrate a method providing a plurality of substantially planar flexible sheet-members 16. Each sheet-member 16 includes an outer surface 18 and an opposite inner surface 20. Outer and inner surfaces 18, 20 include first and second opposed edges 22, 24. Inner surface 20 has a first-edge-adjacent portion 26 with a first surface-fastener patch 28 thereon. In some embodiments, outer surface 18 has a single second surface-fastener patch 30 thereon which extends from near the second edge 24 toward first edge 22 (not shown). In other embodiments as illustrated in FIG. 3, outer surface 18 has more than one second surface-fastener patch 30 thereon.

As illustrated in FIG. 1, sheet-member 16 is wrapped about leafy portion 32 of plant 14 into a substantially cylindrical shape. Sheet-member 16 is temporarily secured together by first and second patches 28, 30 thereof to expose the base 34 of the plant stem 14 and surrounding ground 36. In other embodiments, sheet member 16 can be temporarily secured together by first and second patches 28, 30 thereof in a manner in which base 34 of plant stem 14 is not exposed as illustrated in FIG. 1.

As shown in FIG. 1, groundcover 12 is applied around and between a plant 14 or numerous plants 14 including to the bases 34 of the stems of the plant 14 or plants 14. Once groundcover 12 is applied first and second patches 28, 30 of each sheet-member 16 are decoupled and removed allowing leafy portions 32 of plant 14 to spread over groundcover 12.

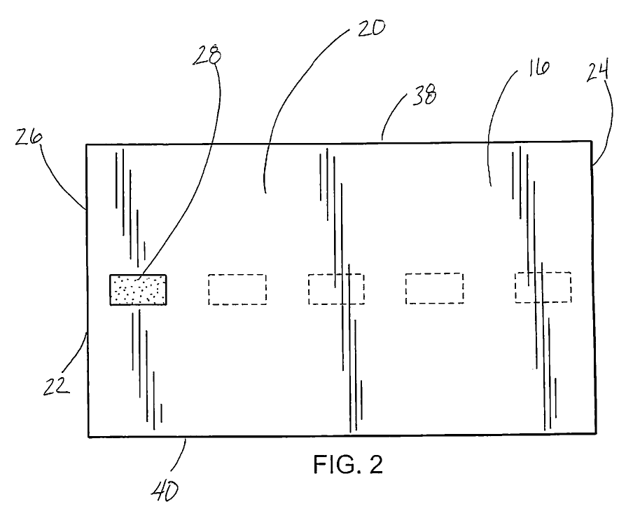

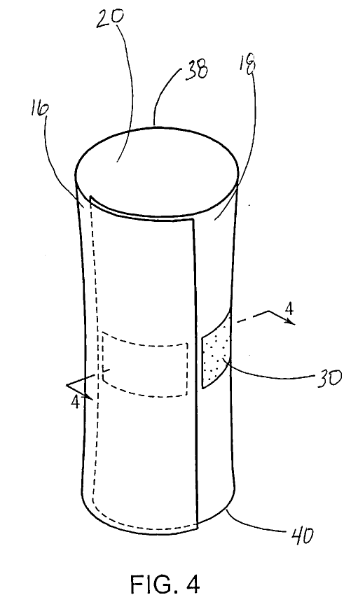

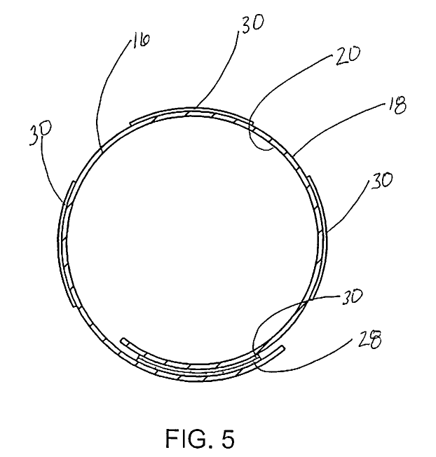

FIG. 2 illustrates inner surface 20 having first patch 28 thereon. First patch 28 is secured to second patch 30 when sheet-member 16 is temporarily secured in a substantially cylindrical shape as shown in FIGS. 4 and 5. FIG. 4 illustrates sheet-member 16 temporarily secured together by first and second patches 28, 30. FIG. 5 is a section of sheet-member 16 taken along section line 4-4 of FIG. 4. FIG. 5 illustrates sheet-member 16 in the temporarily secured position specifically showing the securing connection between first and second patches 28, 30.

FIG. 3 is an embodiment illustrating outer surface 18 having a plurality of surface-fastener patches 30 thereon. Patches 30 in this embodiment are spaced apart on outer surface 18 in a manner facilitating wrapping sheet-member 16 into chosen cylindrical sizes depending on the sizes of plants 14. In some embodiments outer surface 18 of each sheet-member 16 has only one surface-fastener patch 30 thereon (not shown). Patch 30 in this embodiment extends in an elongate manner to facilitate wrapping sheet-member 16 into chosen cylindrical sizes depending on the sizes of plants 14.

First and second surface-fastener patches 28, 30 used in the present method are preferably velcro as illustrated in FIGS. 1-5. However, a variety of materials which have fastening abilities can be used. First and second patches 28, 30 can be formed into numerous shapes and sizes and are not limited to the size or rectangle-shaped patch illustrated in FIGS. 1-5.

First and second surface-fastener patches 28, 30 are interchangeable between outer surface 18 and inner surface 20. First surface-fastener patch 28 can be placed on either outer surface 18 or inner surface 20 and second surface-fastener 30 patch can be placed on either outer surface 18 or inner surface 20. However, each sheet-member 16 must have at least one first surface-fastener patch 28 and at least one second surface-fastener patch 30 to properly function.

Sheet-member 16 in the present method is comprised of a flexible paper or plastic material. Sheet-members 16 each have a thickness preferably in the range of 0.005 to 0.020 thousandths of an inch. Each sheet-member 16 has an upper edge 38 and a lower edge 40 as illustrated in FIGS. 2-4. Each sheet-member 16 has sufficient form such that the dimensions between upper edges 38 and lower edges 40 remain substantially unchanged during wrapping and use as illustrated in FIGS. 1-5. Sheet-member 16 is of sufficient strength such that it is not able to be punctured by laterally extending plant stems or parts.

A wide variety of materials are available for the various parts discussed and illustrated herein. Although the method has been shown and described in conjunction with specific embodiments thereof, it is to be understood that many alternatives, modifications and variations will be apparent to those skilled in the art. Accordingly, it is intended to embrace all such alternatives, modifications and variations that fall within the spirit and broad scope of the appended claims.

1. A method of applying particulate groundcover around plants comprising the steps of:
providing a plurality of substantially planar flexible sheet-members having a thickness in the range of 0.005 to 0.020 thousandths of an inch, each sheet-member comprised of a paper or plastic material and each includes an outer surface and an opposite inner surface and first and second opposed edges, the inner surface having a first-edge-adjacent portion with a first surface-fastener patch thereon, the outer surface. having a second surface-fastener patch thereon extending from near the second edge toward the first edge, each sheet-member having an upper edge and a lower edge, each sheet-member has sufficient form such that the dimensions between the upper edges and lower edges remain substantially unchanged during use;
wrapping each sheet-member about the leafy portion of a plant into a substantially cylindrical shape and temporarily securing together the first and second patches thereof to expose the base of the plant stem and surrounding ground, thereby creating vertical space between the lower edge and the ground;
applying groundcover around and between the plants including to the bases of the stems thereof; and
decoupling the first and second patches of each sheet-member and removing the sheet-members to allow the leafy portions of the plant to spread over the groundcover.

2. The method of claim 1 wherein the providing step further includes the outer surface of each sheet-member has only one surface-fastener patch thereon extending in an elongate manner to facilitate wrapping the sheet-member into chosen cylindrical sizes depending on the sizes of the plants.

3. The method of claim 1 wherein the providing step further includes the outer surface of each sheet-member has a plurality of surface-fastener patches thereon spaced apart on the outer surface in a manner facilitating wrapping the sheet-member into chosen cylindrical sizes depending on the sizes of the plants.

4. The method of claim 1 wherein the providing step further includes the first and second surface-fastener patches are fabric hook-and-loop-fasteners.

5-6. (canceled)
